(19) United States
(12) Patent Application Publication
(10) Pub. No.: US 2004/0136687 A1
(43) Pub. Date: Jul. 15, 2004

(54) Signal processing method to selectively record image signals

(75) Inventor: Chi-Cheng Ju, Hsin-Chu City (TW)

Correspondence Address: TROXELL LAW OFFICE PLLC, SUITE 1404, 5205 LEESBURG PIKE, FALLS CHURCH, VA, 22041, US

(73) Assignee: MediaTek Inc.

(21) Appl. No.: 10/745,598

(22) Filed: Dec. 29, 2003

(30) Foreign Application Priority Data
Jan. 2, 2003 (TW) 092100014

(51) Int. Cl. H04N 5/781

(52) U.S. Cl. 386/46; 386/125

(57) ABSTRACT

This invention provides a signal processing method for image signals. This method selectively records the image signals on a recording medium. The image signals contain at least two image signals with different original image frame rate. After a signal converting process, the original image frame rate will be adjusted to a standard image frame rate specified by an image system standard. At first, this method detects the image signals according to a detection process in order to distinguish at least one image signal with one original image frame rate in the image signals with at least two original image frame rates. After the process of image detection, this method records only desired image signals on the recording medium according to an image selection information.

### BACKGROUND OF THE INVENTION

1. Field of the Invention

This present invention relates to a signal processing method for recording image signals, especially relates to a signal processing method to selectively record image signals on a recording medium.

2. Description of the Prior Art

It is desirable to have a system which automatically detects selected segments of a television signal such as commercial advertisements in real-time during a television broadcast for the purposes of controlling a video cassette recorder (VCR) or a Digital Versatile Disc (DVD) recorder to skip the unwanted broadcast material during recording of the television broadcast. Although a wide variety of techniques have been developed for detecting selected segments of television signals, there have been no sufficiently effective and economical systems that automatically operate in real-time for controlling a recorder to selectively record image signals on a recording medium

Examples of broadcast segment detection systems include systems for detecting commercial advertisements during the playback of a television program on a recorder for the purpose of controlling the recorder to skip or scan over the commercial advertisements during playback such that a viewer may watch the recorded television program without significant commercial advertisement interruptions. One effective system is described in U.S. Pat. No. 5,333,091. With the system of U.S. Pat. No. 5,333,091, an automatic editing device is coupled between a conventional VCR and a conventional television set. As a broadcast program is recorded on a videotape by the VCR, the editing device detects and records the timing and duration of selected events, such as black frames combined with low audio, that separate segments of the broadcast and creates a time-based map of the selected events. After the recording is completed, the editing device analyzes the time-based map and determines therefrom which segments are commercial advertisement segments and which are program segments. The editing device then records control signals on the videotape prior to and following the commercial advertisement segments. Upon playback, the control signals control the VCR to fast-scan over the commercial advertisement segments so that the recorded broadcast can be viewed substantially without interruption. Related techniques are described in U.S. Pat. No. 5,455,630 and in PCT application PCT/US94/00223 published as WO 94/16442.

Another technology showed in U.S. Pat. No. 4,602,297 which stores and delays the output of a received broadcast signal to a VCR until it can determine whether the delayed portion of the broadcast signal includes commercial advertisements. To this end, the system detects commercial advertisements or groups of commercial advertisements within the delayed portion by detecting amplitude drops in the broadcast signal and determining whether time intervals between the amplitude drops correspond to normal durations of commercial advertisements or groups of commercial advertisements. The system then outputs only those portions of the delayed signal to the VCR that do not correspond to commercial advertisements of groups of commercial advertisements. Hence, the broadcast signal is recorded without commercial advertisements for future playback. However, the system does not operate in real-time to detect commercial advertisements within a received broadcast signal. Rather the system instead requires that the received broadcast signal be temporarily stored and delayed. Commercial advertisements may each be one minute or perhaps more in length thereby requiring a significant amount of storage for temporarily storing portions of the broadcast signal and thereby requiring a system which is not sufficiently economical for most purposes. Also, U.S. Pat. No. 4,750,052 and No. 4,782,401 use similar method to detect advertisement signals, delete advertisement signals before outputting the signals to the cassette.

U.S. Pat. No. 4,420,769 and No. 4,750,213 describe a system wherein a human operator identifies program segments to be eliminated from a broadcast signal causing a digital code word or signature for the segment to be stored in memory. Subsequently, if the same segment is encountered, the system automatically compares digitized portions of the received signal with the stored signatures to recognize the segment and then to blank out or otherwise eliminate the segment in real-time. One significant problem with this system is that a human operator must first detect program segments to be eliminated. Also, a significant amount of data processing is required to establish and compare the signatures in a reliable manner.

Besides, some prior arts can select certain specific signal segment. For example, U.S. Pat. No. 5,504,518 stores received signals as digital segments at first, then utilize an expert system to decide whether any desired segments exist in these digital segments. If any segments cannot be recognized by the expert system, further manual control is required.

The main drawbacks of aforementioned prior arts are listed as follows. First, they cannot real time operate and control the recording apparatus while receiving image signals. They have to store and delay some image signals before detecting the undesired image signal segments. Second, it is inevitable to record some undesired image signal segments on a recording medium and wastes a lot of space of recording medium. For example, the apparatus of U.S. Pat. No. 5,333,091 still needs to store undesired advertisement segments. Third, expensive and complicated additional hardware, such as the automatic editing device or large memory storage in U.S. Pat. No. 5,333,091 is needed. This substantially increases the hardware cost of the recording apparatus. The last, the prior arts often require extra manual operation due to the insufficiency of undesired segment detection system. This brings much inconvenience to users.

Conventionally, there are two kinds of TV signal standards: National Television Standards Committee (NTSC) standard and PAL standard. For the NTSC video signal, each frame contains 525 scan lines and is divided into two fields according to the condition whether they are odd or even lines. These two fields are displayed successively. The NTSC video signal has a particular frame rate at about 30 frames/sec or 60 fields/sec. The NTSC standard is popular in United States, Taiwan, Japan, and so on.

For the PAL video signal, each frames contains 625 scan lines. Each frame of the PAL video signal is divided into two fields and displayed successively. But the frame rate of the PAL video signal is 25 frames/sec or 50 fields/sec. The PAL standard is popular in Europe, Austria, and so on.

When image signals are originally recorded by a film (the film image signals), such as the commercials on TV, the particular frame rate is 24 frames/sec, which is different from the frame rate of NTSC video signal or PAL video signal. Therefore, the frame rate of the film image signals needs to be adjusted to meet the frame rate of standard video signals by a telecine procedure before displaying on TV.

The telecine procedure is used to convert the film image signal with a frame rate of 24 frames/sec into the NTSC video signal with the frame rate of 60 frames/sec or the PAL video signal with the frame rate of 50 frames/sec. The telecine procedure can be divided into two kinds: 3:2 pull-down telecine and 2:2 pull-down telecine.

Please refer to FIG. 1. FIG. 1 is a schematic diagram of a conventional 3:2 pull-down telecine procedure. FIG. 1 shows four frames of a motion picture, labeled as A, B, C, and D. At first, each frame A, B, C, and D is respectively separated into two fields, labeled as A1, A2, B1, B2, C1, C2, D1, and D2. While the film image signals are adjusted to meet the standard NTSC TV signals, that is, the motion pictures displayed at 24 frames/sec is going to be displayed at 30 frames/sec, some fields such as B1 and D2 shown in FIG. 1 will be repeated once. The display sequence of the fields shown in FIG. 1 is A1, A2, B1, B2, B1, C2, C1, D2, D1, and D2. This telecine procedure is repeated every 4 frames of the film image signals.

Since the film image signals after the telecine procedure have different properties from original standard TV signals, such as the repetition of certain fields after 3:2 pull-down telecine, image signals belonging to the film signals, such as TV advertisement signals, can be differentiated from image signals belonging to common TV programs by detecting the repetition.

It is therefore a primary objective of the present invention to provide an image signal processing method to solve the drawbacks of prior arts by detecting the characteristic of image signals undergone the telecine procedure. The present invention also makes it possible to selectively record image signals on a recording medium.

### SUMMARY OF THE INVENTION

The primary objective of the present invention provides an image signal processing method and an image recording apparatus to selectively record image signals on a recording medium.

In a preferred embodiment, the signal processing method of the present invention is selectively recording image signals on a recording medium. The image signals comprise at least two kinds of image signals with different original image frame rate. After a signal converting procedure, the original frame rate of the image signals are adjusted to meet a standard image frame rate specified by an image system standard, such as the NTSC standard or the PAL standard.

The method first detects the image signals according to an image signal detecting procedure, then selects at least one image signal with one particular original image frame rateout of the image signals with at least two original image frame rates. After the detection is completed, the method records only the desired image signals on a recording medium according to an image selection information.

The present invention provides an image recording apparatus and a signal processing method for determining the original image frame rate of the image signals belonging to the film signals or the video signals. Then decide whether to record the image signals on a recording medium. Thereby, the present invention needs no extra hardware to real time select the desired image signals and record on a recording medium. The present invention can accurately sift image signals without any manual operation.

### BRIEF DESCRIPTION OF THE DRAWINGS

FIG. 1 is a schematic diagram of a conventional 3:2 pull-down telecine procedure.

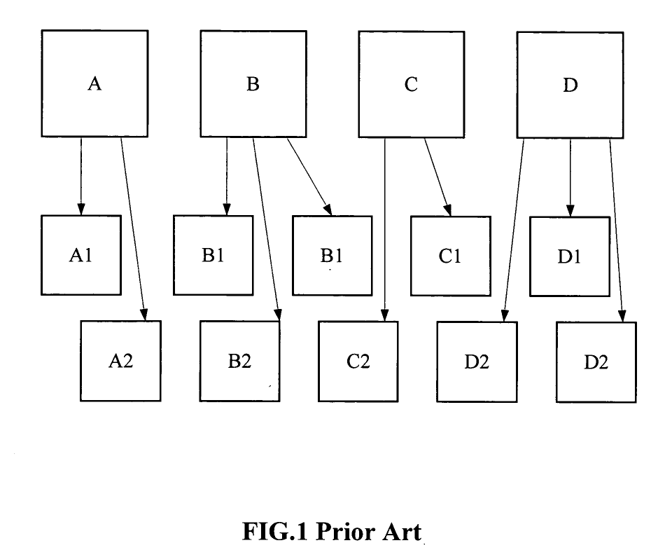

FIG. 2. is the block diagram of the image recording apparatus 10 of the present invention.

FIG. 3 is the flow chart of the signal processing method in the present invention and refer to the image recording apparatus as shown in FIG. 2.

FIG. 4 is the block diagram of an image recording apparatus of another embodiment in the present invention.

FIG. 5 is the function block diagram of the MPEG audio/video codec as shown in FIG. 4.

FIG. 6 is the function block diagram of the video interface unit as shown in FIG. 5.

### DETAILED DESCRIPTION OF THE INVENTION

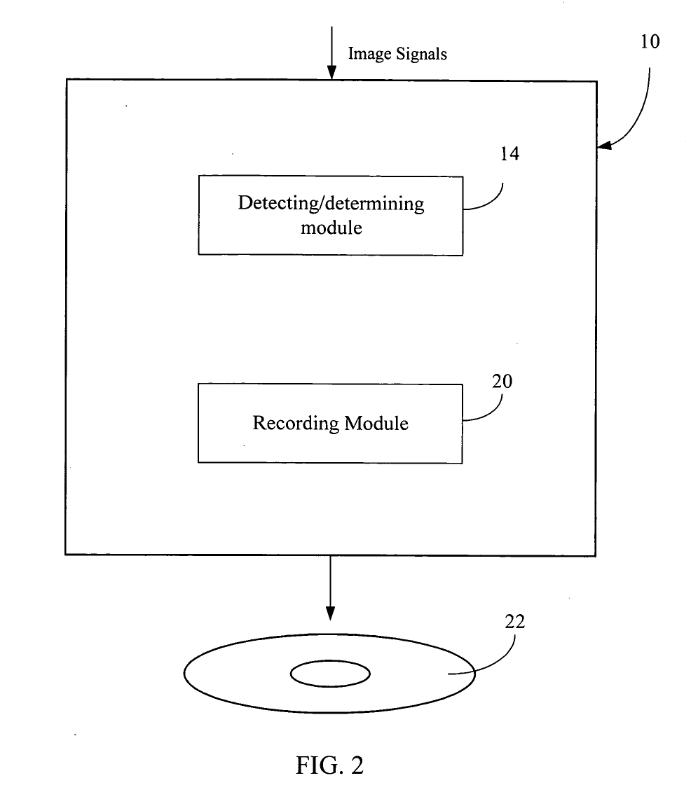

Please refer to FIG. 2. FIG. 2. is the block diagram of the image recording apparatus 10 of the present invention. The present invention provides an image recording apparatus 10 to selectively record image signals complying with an image system standard, such as NTSC or PAL, on a recording medium 22. The image recording apparatus 10 can be a cassette recording apparatus (such as VHS, VCR, and a digital video recorder), a disk recording apparatus (such as a CD-R/RW and DVD video recorder), a computer or a hard-disk video recorder. The recording medium 22 can be a traditional VHS video cassette tape, a digital video recorder cassette (such as a DV cassette tape and a Mini DV cassette tape), a CD-R, a CD-RW, a digital versatile disk (including a DVD-RAM, a DVD-R, a DVD−RW and a DVD+RW), a hard disk, and so on. As shown in the embodiment in FIG. 2, the image recording apparatus 10 would record desired image signals on the recording medium 22.

The image signals in the present invention comprise at least two kinds of image signals with different original image frame rates. For example, one is the film signals (FS) of slower original image frame rate and the other is video signals (VS) with faster original image frame rate. The VS can be the NTSC VS or PAL VS in prior arts. The number of picture frames per unit time for the FS is less than the number of picture frames per unit time for the VS. After a signal converting procedure, such as the telecine procedure in prior arts, the picture frames of FS and of VS can be displayed substantially at the same standard image frame rate, such as the frame rate of NTSC VS or PAL VS.

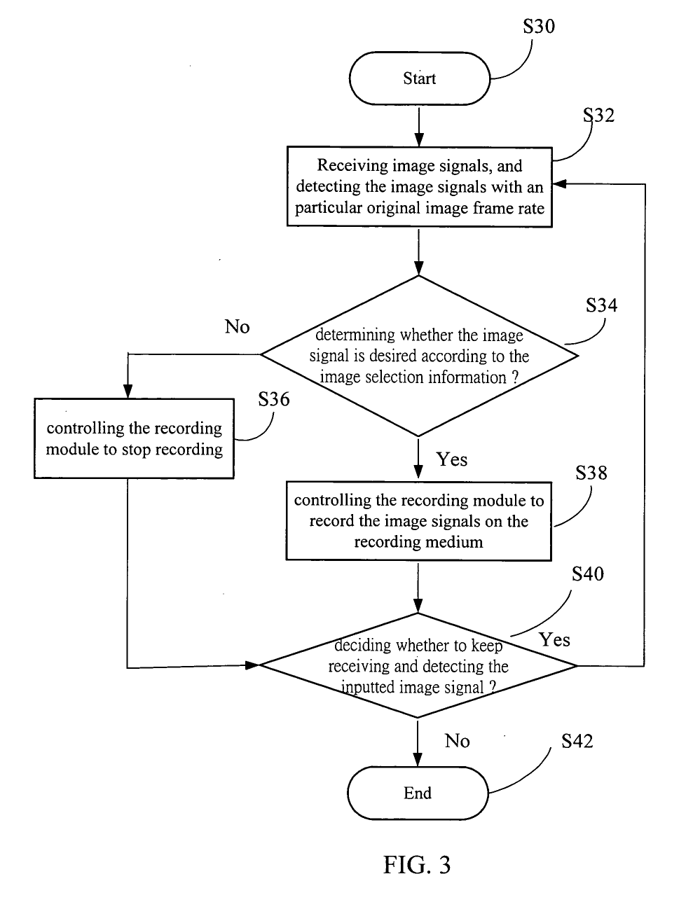

The image recording apparatus 10 comprises a detecting/determining module 14 and a recording module 20. The detecting/determining module 14 is used for receiving and detecting inputted image signals. The detecting/determining module 14 would distinguish the image signals desired to be recorded. That is, it would distinguish one image signal with one original image frame rate out of the image signals with at least two original image frame rates by an image signal detecting procedure, and would identify which kind of image signal is the desired one to be recorded. The recording module 20 records only the desired image signals on the recording medium 22 when receiving those desired image signals. Moreover, the detecting/determining module 14 determines whether the image signals are the desired image signals according to an image selection information. When receiving the desired image signals, the recording module 20 records the desired image signals on the recording medium 22. On the contrary, the recording module 20 stops recording when receiving undesired image signals. Please refer to FIG. 3. FIG. 3 is the flow chart of the signal processing method in the present invention and refer to the image recording apparatus 10 as shown in FIG. 2. The method comprises the following steps:

Step S30: start;

Step S32: continuously receiving the inputted image signals, detecting and determining at least one kind of image signals with a particular original image frame rate;

Step S34: after completing the determination, determining whether the image signal is desired according to the image selection information; if not, going to Step S36; if yes, going to Step S38;

Step S36: controlling the recording module 20 to stop recording and going to Step S40;

Step S38: controlling the recording module 20 to record the image signals on the recording medium 22 and going to Step S40;

Step S40: deciding whether to keep receiving and detecting the inputted image signals; if not, going to Step S42; if yes, going to Step S32;

Step S42: end.

The detecting/determining method of Step S32 determines the image signals as FS according to the field repetition characteristic of FS telecine procedure and FS is thus differentiated from other common standard TV signal. In the meanwhile, Step S34 decides to record FS or VS on the recording medium 22 according to the image selection information.

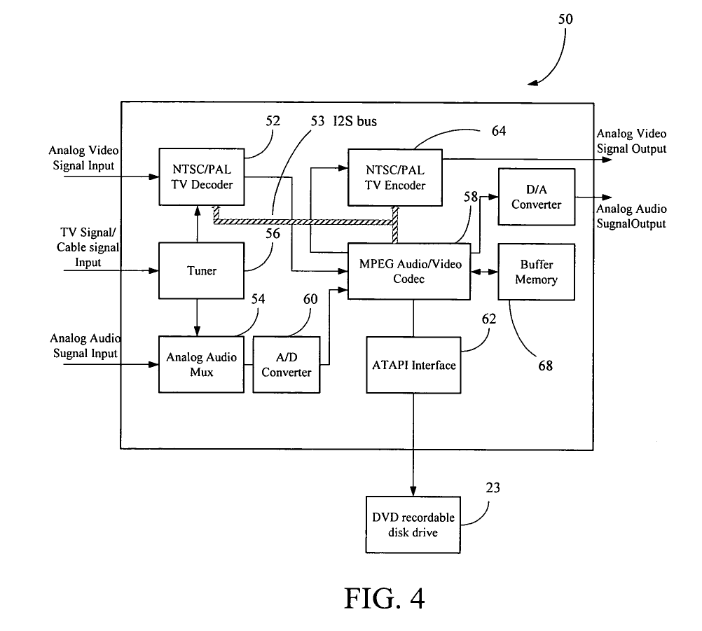

Please refer to FIG. 4. FIG. 4 is the block diagram of an image recording apparatus 50 of another embodiment in the present invention. In this embodiment, the image recorder apparatus 50 is a DVD recorder and the recording module is a DVD recordable disk drive 23. The recording module can also be a hard disk in a computer or other similar image recording devices. The image recording apparatus 50 mainly comprises a NTSC/PAL TV decoder 52, an analog audio mux 54, a tuner 56, a MPEG audio/video codec 58, an A/D converter 60 and an ATAPI interface 62.

Signals from TV or from other image systems comprise analog video signals and analog audio signals. The analog video signals and analog audio signals are separately inputted into the NTSC/PAL TV decoder 52 of the image recording apparatus 50 and analog audio mux 54. Signals from TV antenna or from cables are inputted into the tuner 56, then into the NTSC/PAL TV decoder 52 and the analog audio mux 54. NTSC/PAL TV decoder 52 demodulates the analog video signals, then transmits them to the MPEG audio/video codec 58. The analog audio mux 54 picks up the analog audio signals, then digitalizes them by the A/D converter 60 and transmits them to the MPEG audio/video codec 58.

The MPEG audio/video codec 58 compresses the received signals and transmits them to DVD recordable disk drive 23 by ATAPI interface 62. Therefore the signals can be recorded on a DVD disk, such as a DVD-RAM, a DVD-R, a DVD−RW or a DVD+RW.

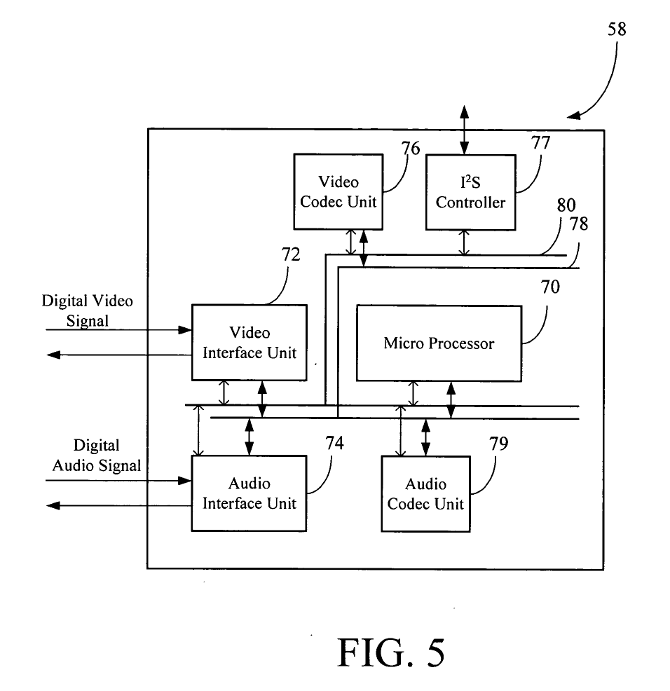

Please refer to FIG. 5. FIG. 5 is the function block diagram of the MPEG audio/video codec 58 as shown in FIG. 4. MPEG audio/video codec 58 comprises a micro-processor 70, a video interface unit 72, an audio interface unit 74, a video codec unit 76 and an audio codec unit 79. Two kinds of buses, a 64-bit wide data bus 78 and a 16-bit wide register bus 80, are employed for connecting the different components or units. The MPEG audio/video codec 58 also comprises an I²S controller 77. I²S bus 53 is used for controlling the NTSC/PAL TV decoder 52 and the NTSC/PAL TV encoder 64.

The microprocessor 70 is mainly used for controlling all function components or units in the MPEG audio/video codec 58. The audio interface unit 74 provides an interface to connect between the MPEG audio/video codec 58 and external audio devices. The video codec unit 76 provides a compression/decompression function of calculation for all MPEG video signals. The audio codec unit 79 provides a compression/decompression function of calculation for all MPEG audio signals.

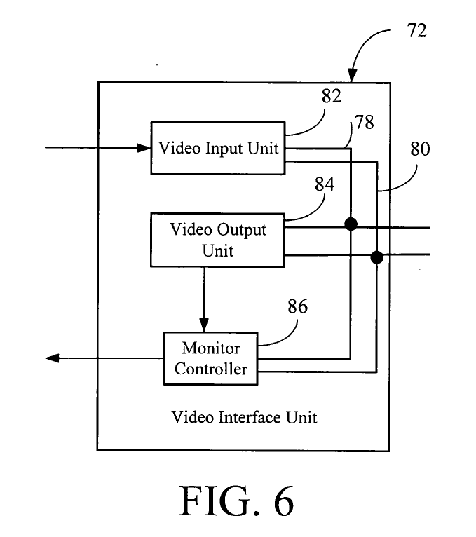

FIG. 6 is the function block diagram of the video interface unit 72 as shown in FIG. 5. The video interface unit 72 comprises a video input unit 82, a video output unit 84 and a monitor control unit 86. Each unit connects to the 64-bit wide data bus 78 and the 16-bit wide register bus 80. The functions of video output unit 84 include multiple processing procedures, such as vertical/horizontal scaling and converting the image signal format or the frame rate to meet the DVD standard. The monitor control unit 86 mixes word or picture data from a buffer memory 68 with image signals processed by the video output unit 84 to correctly generate image information stream and transmit them to the NTSC/PAL TV encoder 64. The video input unit 82 is used for receiving digital image signals demodulated by the NTSC/PAL TV decoder 52 to select active areas, perform chroma conversion and perform scene detection for inputted digital video signal. Scene detection is to detect whether the scene change event occurs in the image signals by a scene change detection procedure. If the scene changes, the video codec unit 76 will be informed to compress the input video signal by means of intra picture compression to improve compression efficiency. The video input unit 82 also processes a 3:2 pull down detection to detect whether image signals have been processed by the telecine procedure and thus have 3:2 pull down repetitive fields. The video input unit 82 then finds out the repetitive fields and does not compress them so as to reduce the loading of the video codec unit 76 in the furtherance and improve the efficiency of compression.

The 3:2 pull down detection, the main function of the video input unit 82 as shown in FIG. 6., is similar to the detecting/determining module 14 shown as FIG. 2. Both of them are used for detecting the repetitive fields in image signals after the telecine procedure. According to the results of detection, therefore, the video input unit 82 can further determine whether the image signal is either FS or VS by identifying the original image frame rate of the image signals, and then inform the microprocessor 70. The microprocessor 70 can decide whether to stop recording or continue recording according to this image selection information. If recording needs to stop, the microprocessor 70 will stop the compression of the video codec unit 76 and stop the recording operation of DVD recordable disk drive 23. The video input unit 82 keeps on detecting the 3:2 pull down to determine whether the original image signals change again, and inform microprocessor 70 to determine whether to record or not. If recording needs to continue again, the microprocessor 70 will restart the compression function of the video codec unit 76 and transmit the compressed image information stream to the DVD recordable disk drive 23 through the ATAPI interface 62. The DVD recordable disk drive 23 then records the image information stream on the DVD.

Nowadays when the TV programs are shown on the TV channels, TV advertisement interludes often make inconvenient the audience who wants to record the program content by the image recording apparatus. By the video interface unit 72 of the present invention, the NTSC/PAL TV decoder 52 of the image recorder apparatus 50 receives TV image signals and transmits decoded digital video signal to the video interface unit 72. Since the common TV advertisements usually produced by the films, the image signals of the commercials need undergoing a telecine procedure before displaying on a TV channel. Hence, if repetitive fields are detected in part of image signals by the video input unit 82 of the video interface 72, these image signals can surely be determined that they belong to the TV advertisements and need not to be recorded on the DVD disk. Therefore the present invention needs no extra expensive hardware, and can real time operate to selectively record the desired signals on the recording medium merely by improving the original function of the video interface unit 72.

In the embodiments mentioned above, the microprocessor 70 and the video input unit 82 continuously determine whether to record or not. However, the control mechanism can be activated only when some particular condition happens so as to reduce the loading.

Common image signals usually comprise a plurality of different scenes and every scene comprises a plurality of image frames. According to another embodiment of the present invention, a scene detector of the video input unit 82, shown as FIG. 6, can further detect the scene change of the image signals by the scene change detection procedure. The scene change or a new scene can happen during the TV programs or between TV programs and advertisements. The determination procedure can also be triggered only when a new scene appearing in the image signals is detected by the scene change detection procedure. After the determination procedure is triggered, the microprocessor 70 would then decide whether to stop recording or to keep on recording according to the information provided by the video input unit 82, which informs that the inputted image signals are either FS or VS. Otherwise, if no new scene is detected by the scene detector, the microprocessor 70 will stay in the last action (stop recording or keep on recording) without making new determination. By means of the scene detector, the microprocessor 70 needs not to continuously determine whether to record or not. The advertisements can still be exactly detected and not recorded to the recording media, while the loading of the microprocessor 70 can also be reduced.

The present invention provides an image recording apparatus and a signal processing method for image signals. By utilizing the video input unit 82 of the video interface unit 72 in the MPEG audio/video codec 58 to detect the repetitive fields of the image signals produced by telecine procedure, the apparatus and method of the present invention can identify the original image frame rate of the image signals and decide whether they are the film signals of advertisement or the video signals of TV programs. Thereby, the present invention needs no extra hardware and can record only the desired image signals on the recording medium precisely and automatically and without any manual operations.

The description of the above-mentioned preferred embodiments provides a better understanding on the strengths and spirits of this present invention, not to limit the domain of the invention. Moreover, it aims to include various modification and arrangement parallel in form into the domain of the patent applied by this present invention. Due to the above mention, the domain of the patent applied by the invention should be explained in a macro view to cover all kinds of possible modification and arrangement of equal form.

What is claimed is:

1. A signal processing method for selectively recording image signals on a recording medium, the image signals comprising at least two kinds of image signals, respectively with different original image frame rate; after a signal converting procedure, the original image frame rate of the image signals being adjusted to meet a standard image frame rate specified by an image system standard, the signal processing method comprising:
according to an image signal detecting procedure, detecting the image signals to determine at least one image signal with one particular original image frame rateout of the image signals with at least two original image frame rates; and
after the image signal determination, recording only the desired image signals on the recording medium according to an image selection information.

2. The signal processing method of claim 1, wherein the image signals comprise film signals with a slower original image frame rate and video signals with a faster original image frame rate, and the number of picture frames per unit time for film signals is less than the number of picture frames per unit time for video signals.

3. The signal processing method of claim 2, wherein the signal converting process repeats certain fields of the film signals to meet the standard signal frame rate specified by the image system standard.

4. The signal processing method of claim 2, wherein the video signal is a NTSC video signal.

5. The signal processing method of claim 2, wherein the video signal is a PAL video signal.

6. The signal processing method of claim 1, wherein the signal converting process is telecine procedure.

7. The signal processing method of claim 3, wherein the detecting procedure is to continuously detect the image signals, and determine the image signals as the film signals if they have repetitive fields, and then record the film signals on the recording medium according to the image selection information.

8. The signal processing method of claim 3, wherein the detecting procedure is to continuously detect the image signals and determine the image signals as the film signals if they have repetitive fields, and then not to record the film signals on the recording medium according to the image selection information.

9. The signal processing method of claim 3, wherein the detecting procedure is continuously detect the image signals and determine the image signals as the video signals if they do not have repetitive fields, and then record the video signals on the recording medium according to the image selection information.

10. The signal processing method of claim 3, wherein the detecting procedure is to continuously detect the image signals and determine the image signals as the video signals if they do not have repetitive fields, and then not to record the video signals on the recording medium according to the image selection information.

11. The signal processing method of claim 3, wherein the image signals comprise a plurality of different scenes and each scene comprises the plurality of picture frames.

12. The signal processing method of claim 11, wherein the signal processing method is to detect the scene change by a scenes change detection procedure.

13. The signal processing method of claim 12, wherein only when the scene change detection procedure has detected scene change happening in the image signals, then the detecting procedure begins to detect the image signals and to identify the image signals as the film signals if repetitive fields are found and then to record the scene on the recording medium.

14. The signal processing method of claim 12, wherein only when the scene change detection procedure has detected scene change happening in the image signals, then the detecting procedure begins to detect the image signals and to identify the image signals as the film signals if repetitive fields are found and then not to record the scene on the recording medium.

15. The signal processing method of claim 12, wherein only when the scene change detection procedure has detected scene change happening in the image signals, then the detecting procedure begins to detect the image signals and to identify the image signals as the video signals if no repetitive fields are found and then to record the scene on the recording medium.

16. The signal processing method of claim 12, wherein only when the scene change detection procedure has detected scene change happening in the image signals, then the detecting procedure begins to detect the image signals and to identify the image signals as the video signals if no repetitive fields are found and then not to record the scene on the recording medium.

17. An image signal recording apparatus for selectively recording image signals on a recording medium, the image signals comprising at least two kinds of image signals, respectively with different original image frame rate; after a signal converting procedure, the original image frame rate of the image signals being adjusted to meet a standard image frame rate specified by an image system standard, the signal recording apparatus comprising:
a detecting/determining module to receive and detect the image signals, to determine at least one image signal with one particular original image frame rate out of the image signals with at least two original image signal frame rates, and to determine the image signals desired to be recorded; and
a recording module to record only the desired image signals on the recording medium when receiving the desired image signals;
wherein the detecting/determining module selects the desired image signals according to an image selection information and controls the recording module for recording.

18. The signal recording apparatus of claim 17, wherein the image signals comprise film signals with a slower original image frame rate and video signals with a faster original image frame rate, and the number of picture frames per unit time for film signals is less than the number of picture frames per unit time for video signals.

19. The signal recording apparatus of claim 18, wherein the video signal is a NTSC video signal.

20. The signal recording apparatus of claim 18, wherein the video signal is a PAL video signal.
